(19) United States
(12) Patent Application Publication
(10) Pub. No.: US 2014/0049534 A1
(43) Pub. Date: Feb. 20, 2014

(54) Efficient Method Of Rendering A Computerized Model To Be Displayed On A Computer Monitor

(71) Applicant: Philip Ho, Livermore, CA (US)

(72) Inventor: Philip Ho, Livermore, CA (US)

(73) Assignee: Livermore Software Technology Corp, Livermore, CA (US)

(21) Appl. No.: 13/585,080

(22) Filed: Aug. 14, 2012

(51) Int. Cl. G06T 15/00; G06T 1/00

(52) U.S. Cl. 345/419; 345/418

(57) ABSTRACT

Efficient method of rendering a computerized model to be displayed on a computer monitor is disclosed. The computerized model contains a plurality of finite elements organized in groups with each group containing same type of finite elements. For achieving efficient rendering of the computerized model, first and second threshold numbers for further partitioning the computerized model are determined using a set of criteria based on available resources of the computer system and characteristics of the computerized model. Any group having the number of elements more than the first number is divided into subgroups. The number of elements in each subgroups is configured to contain no more than the second number. Both first and second numbers are “tune-able” for particular situations depending upon a number of factors including, but not limited to, power of computer processor, random access memory available, power of graphical co-processor and/or associated memory, and communication bandwidth.

### FIELD OF THE INVENTION

The present invention generally relates to computer aided engineering, more particularly to methods and systems for efficiently rendering a very large computerized model to be displayed on a computer monitor.

### BACKGROUND OF THE INVENTION

Engineering products such as automobile and its components have been designed with computer aided engineering (CAE). Not only is CAE being used for designing finished products, but also for manufacturing procedures of product (e.g., sheet metal forming of a part).

CAE is conducted using a computerized model (e.g., finite element analysis mesh model), which contains a number of finite elements. Creating such large model requires automated procedure including an interactive visualization tool referred to as preprocessor. Furthermore, examining the computer simulation results also requires interactive visualization software referred to as postprocessor. With the advance of the computer technologies, computerized model has become very large (e.g., several million elements). As a result, rendering and displaying such large computerized model on a computer monitor may take quite a long delay in terms of real time. These drawbacks can hinder productivities of engineers and designers hence delaying a product development. Furthermore, displaying such computerized model may require additional computer resources such as additional random access memory or more powerful graphics processor, which may indirectly increase the product costs.

It would therefore be desirable to have an efficient method for rendering a very large computerized model to be displayed on a computer monitor.

### BRIEF SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The present invention is directed to an efficient method of rendering a very large computerized model (e.g., finite element analysis mesh model) to be displayed on a computer monitor.

According to one aspect of the present invention, a computerized model (e.g., finite element analysis model) representing an object of interest to be displayed is defined and received in a computer system. The computerized model contains a plurality of finite elements organized in one or more groups with each group containing same type of finite elements (e.g., solid, shell elements). The object of interest includes, but is not limited to, a product, a part or component of a product, components for manufacturing a part or product (e.g., sheet metal forming of a part). Next, for achieving efficient rendering of the computerized model, a pair of threshold numbers (i.e., first and second numbers) for further partitioning groups are determined using a set of criteria based on available resources of the computer system and characteristics of the computerized model.

Then any group having the number of elements more than the first number is divided into two or more subgroups. The number of elements in each subgroups is configured to contain no more than the second number. Both first and second numbers are “tune-able” for particular situations depending upon a number of factors including, but not limited to, power of computer processor, random access memory available, power of graphical co-processor and/or associated memory, and communication bandwidth. The first number is larger than the second number.

Next, according to a viewport dynamically defined by user (e.g., interactively manipulating the computerized model), only those groups and/or subgroups (collectively referred to as rendering units) that are relevant to the viewport (e.g., each unit's geometric bounds overlaps respective bounds of the viewport) are chosen for rendering. Because each of the chosen rendering unit is so sized for efficient processing with the particular resources of the computer system, hence efficiency of displaying the computerized model is ensured.

According to another aspect, dividing a group into a plurality of subgroups is based on a procedure depending upon geometrical dimensions of the structure or part the group represents. Each dividing or partitioning starts in the longest dimension.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an exemplary process of efficiently rendering a computerized model, according to an embodiment of the present invention;

FIG. 2A is a diagram showing a first exemplary computerized model;

FIG. 2B is a diagram showing a second exemplary computerized model;

FIG. 3 is a diagram showing an exemplary viewport and an exemplary group of a computerized model, according to an embodiment of the present invention;

FIG. 4 is a diagram illustrating a first exemplary partitioning scheme in accordance with one embodiment of the present invention;

FIG. 5 is, a diagram illustrating a second exemplary partitioning scheme to be avoid, according to an embodiment of the present invention;

FIG. 6 is a diagram showing geometrical dimensions of an exemplary group, according to another embodiment of the present invention; and

FIG. 7 is a functional block diagram showing salient components of an exemplary computer, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

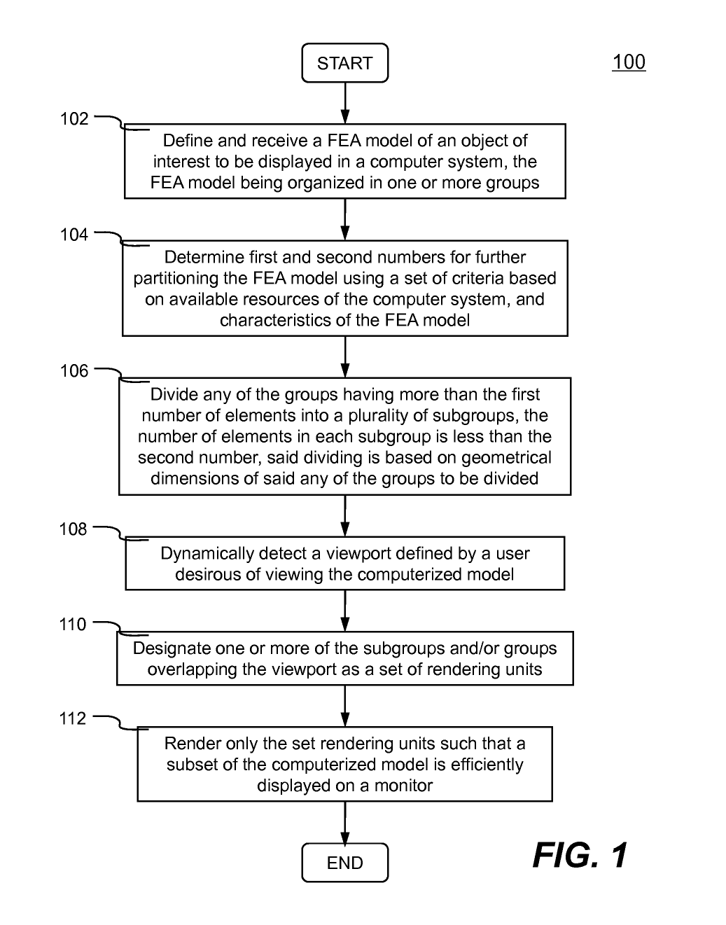

Embodiments of the present invention are discussed herein with reference to FIGS. 1-7. However, those skilled in the art will readily appreciate that the detailed description given herein with respect to these figures is for explanatory purposes as the invention extends beyond these limited embodiments.

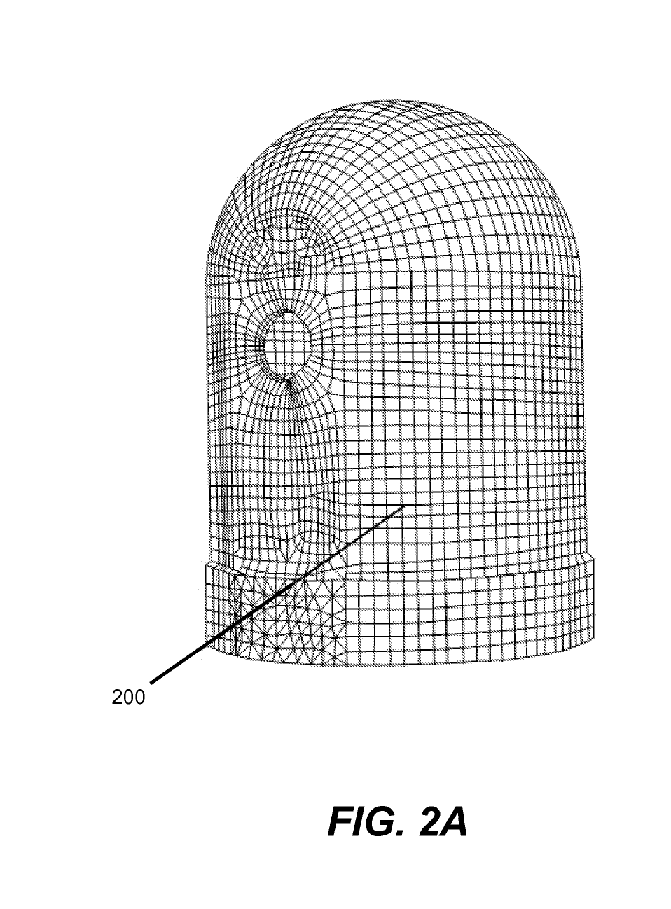

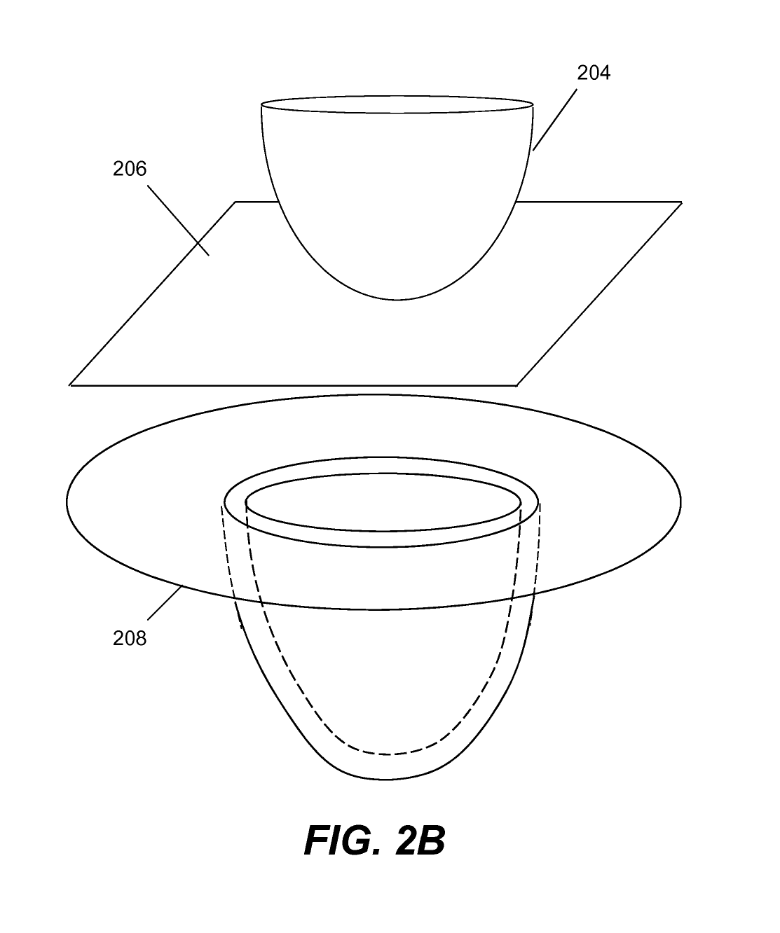

The present invention is directed to an efficient method of rendering a very large computerized model (e.g., finite element analysis mesh model) to be displayed on a computer monitor. In one embodiment, FIG. 1 is a flowchart illustrating an exemplary process 100 of efficiently rendering a very large computerized model to be displayed on a monitor. Process 100 is implemented in software and preferably understood with other figures, for example, FIGS. 2-7.

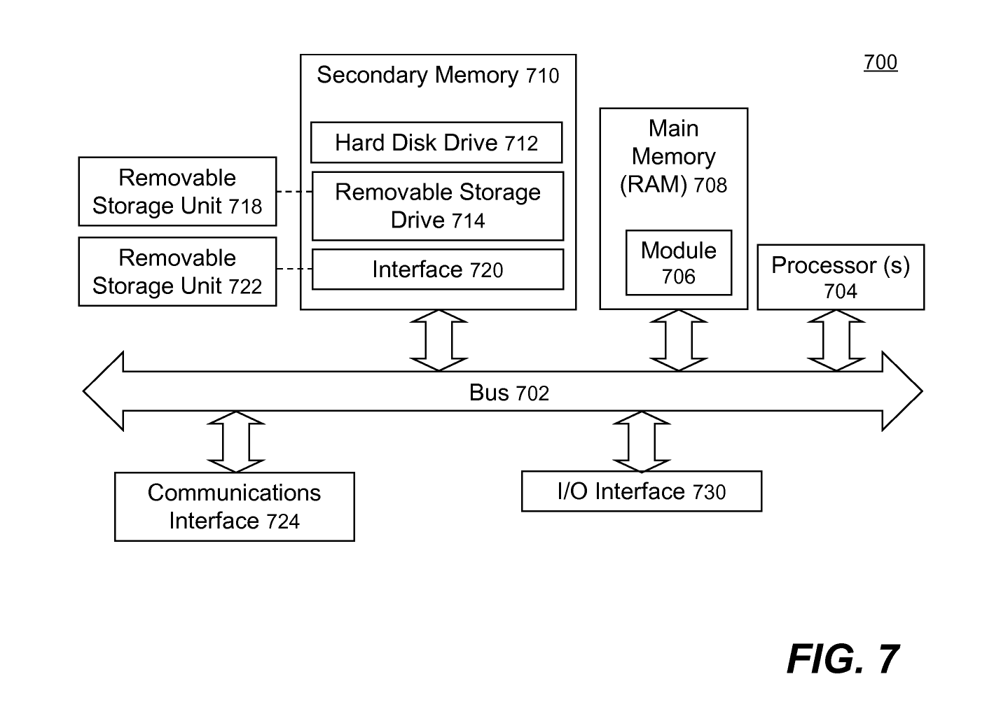

Process 100 starts at step 102 by receiving a computerized model to be displayed on a computer monitor in a computer system (e.g., computer 700 in FIG. 7) having an application module for graphically displaying a computerized model installed thereon. Computerized model represents an object of interest, which can be a product or a structure, or it can be a group of structures used for manufacturing a product, for example, a finite element analysis mesh model 200 shown in FIG. 2A, or a sheet metal stamping manufacturing setup in FIG. 2B. In the second example, the computerized model represents a punch 204, a sheet metal blank 206 and a die 208. The sheet metal blank 206 is formed into a part by pushing the punch 204 into the die 208. The computerized model contains a number of elements (e.g., finite elements, polygons, etc.) organized in groups. Each group contains a number of same type of elements (e.g., solid or shell elements) representing a part or a component of a product or structure. In one embodiment, each group is categorized with a unique part ID. In the second example shown in FIG. 2B, sheet metal blank 206 may be represented as one huge group of two-dimensional shell elements (e.g., few million elements).

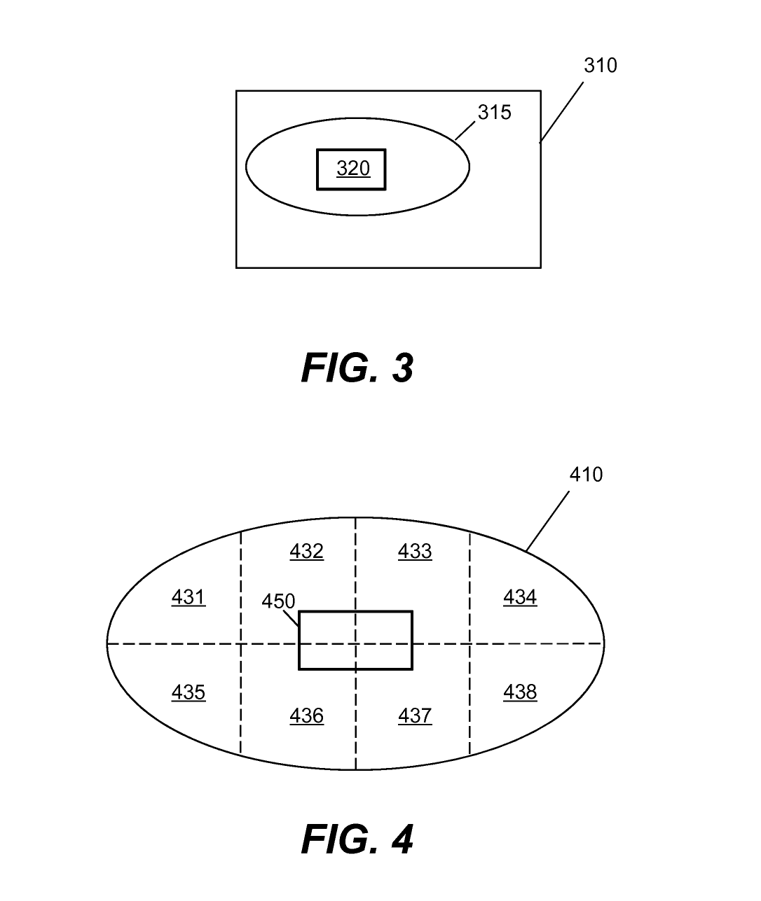

A user desirous of viewing a computerized model defines a viewport (e.g., viewport 320 of FIG. 3) that sets the boundary (i.e., geometric bounds) within the computerized model for displaying. This is generally performed dynamically, for example, interactively manipulating a computerized model through a graphical display application module in a computer system. In one embodiment, the geometric bounds comprises a three-dimensional bounding box. A bounding box 600 (dotted line box) of an exemplary group 610 (ellipsoid) is shown in FIG. 6. In order to display the computerized model, computer system must render all of the groups overlapping the viewport. For a computerized model having a huge group of elements that overlaps the viewport, the entire group must be rendered even if the viewport covers a small portion of the group. In sheet metal forming simulation, a very large group of elements (more than one million elements) is generally used for representing the sheet metal blank 206. As a result, a delay could happen when computer resources are not adequate, for example, a computer having less powerful processor or small amount of memory. Even in a more powerful computer system, another task could be simultaneously performed thus causing some of the computer resources being unavailable.

According to one embodiment of the present invention, such group having large number of elements is further divided or partitioned into subgroups. At step 104, a pair of threshold numbers (i.e., first and second numbers) for further partitioning the computerized model are determined using a set of criteria based on available resources of the computer system, characteristic of the computerized model. Available resources include, but are not limited to, memory, processor, graphics co-processor, communication bandwidth, etc. Characteristics of a computerized model include number of elements in a group, type of the elements, etc. Both first and second numbers can be preset statically or changed dynamically basing on the workload of the computer system. The viewport defines a boundary of a subset of the computerized model for viewing. FIG. 3 is a diagram showing an exemplary relationship between a viewport 320 and a computerized model 310. In this example, viewport 320 is located within group 315. For illustration simplicity in FIG. 3, elements are not shown, the computerized model 310 is shown having a rectangular shape and group 315 having an oval shape in two-dimension. In reality, the model, group or groups can be any shape and in three-dimension. The present invention has no limit as to the shape of the model, group or groups. It is noted that the viewport 320 changes dynamically by the user, for example, interactively manipulating a computerized model.

Next, at step 106, any group having the number of elements more than the first number is divided into two or more subgroups. Each subgroup is configured to have the number of elements less than the second number. Subpartition or subdivision of a group is performed basing on geometric bounds of the group. FIG. 6 shows an exemplary group's 610 geometric dimensions 602-606. Division starts by dissecting the longest geometric dimension 602 of a group or a subgroup. Each of the subgroups and the non-divided groups is referred to as rendering unit for rendering purpose.

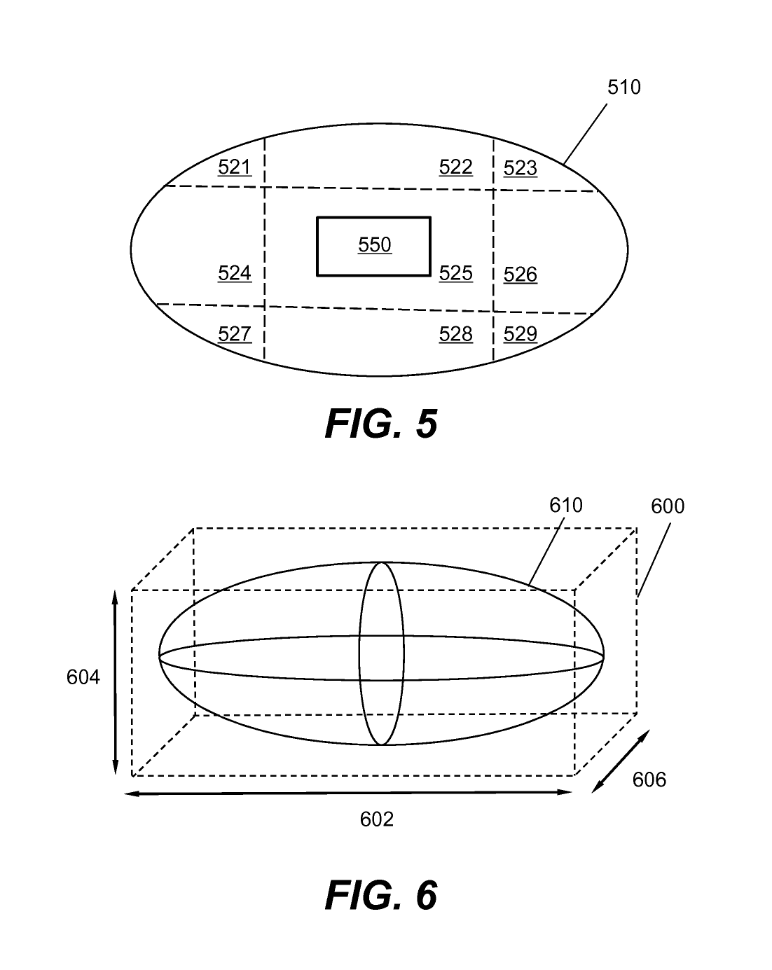

Next, at step 108, the viewport (e.g., viewport 450 in FIG. 4 or viewport 550 in FIG. 5) is dynamically detected. This can be done with a number of well-known methods through the application module (graphically displaying software) installed on the computer system. Then, groups and/or subgroups that overlap the viewport is/are designated as a set of rendering units at step 110. To determine the overlapping, geometric bounds (e.g., bounding box 600 of FIG. 6) of a viewport are compared with respective geometric bounds of each group/subgroup.

At step 112, the computer system only need to render rendering units such that required number of elements for displaying the computerized model through the viewport is reduced. In an ideal situation, only one rendering unit is required for a particular viewport 550 shown in FIG. 5.

First and second examples of such subdivision scheme is shown in FIGS. 4 and 5, respectively. For illustration simplicity, both examples are shown in two-dimension. The present invention can be applied to three-dimensional groups in a three-dimensional computerized model.

In the first example, a group 410 is subdivided or subpartitioned into eight subgroups 431-438. The division scheme is to start dividing the longest dimension first. To display the computerized model through a viewport 450 requires the computer system renders subgroups 432, 433, 436 and 437 (i.e., subgroups or display units relevant to the viewport).

In the second example shown in FIG. 5, a group 510 is divided into nine subgroups 521-529. In this scheme, only one subgroup 525 needs to be rendered when displaying the computerized model through the viewport 550.

Both subdivision or partition schemes reduce the size of a large group thereby achieving the objective of the present invention.

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the computerized model (e.g., groups and subgroups) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a two-dimensional oval shape has been shown as a generic group in a computerized model, a group of elements can have numerous different geometric shapes and dimensions. Additionally, whereas an ellipsoid has been shown and described as the shape of an exemplary group in FIG. 6, the group can have any geometric shape to achieve the same in the present invention, for example, an irregular shape containing a number of elements. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of efficiently rendering a computerized model to be displayed on a monitor comprising:
receiving a computerized model in a computer system having a application module for graphically displaying the computerized model installed thereon, said computerized model containing a plurality of elements organized in one or more groups;
determining first and second numbers used for further partitioning of the computerized model with a set of criteria based on available resources of the computer system, characteristics of the computerized model;
partitioning each group having more than the first number of elements into a plurality of subgroups with each subgroup having less than the second number of elements in accordance with a set of partitioning rules;
dynamically detecting a viewport defined by a user desirous of viewing the computerized model;
designating one or more of the groups and/or the subgroups overlapping the viewport as a set of rendering units; and
rendering said set of rendering units in the computer system such that portion relevant to the viewport can be efficiently displayed on a monitor operatively adapted thereto.

2. The method of claim 1, wherein said computerized model comprises a finite element analysis mesh model.

3. The method of claim 1, wherein said computerized model represents a product.

4. The method of claim 1, wherein said computerized model represents one or more structures in a manufacturing setup of a product.

5. The method of claim 1, wherein said resources of the computer system include one or more of computer memory, computer processor, graphics co-processor, communication bandwidth.

6. The method of claim 1, wherein said characteristics of the computerized model include one or more of type of elements, number of elements, physical dimension represented by the computerized model.

7. The method of claim 1, wherein said set of partitioning rules comprises dividing said each group in said each group's longest geometric dimension.

8. The method of claim 1, wherein said designating said one or more of the groups and/or the subgroups overlapping the viewport as a set of rendering units further comprises comparing the viewport's geometrical bounds with respective geometric bounds of said each of said one or more of the groups and/or the subgroups.

9. The method of claim 1, wherein said each group contains same type of elements representing a part or a component of a product.

10. The method of claim 1, wherein said first number is great than said second number and both said first and second numbers are integers great than one.

11. A system of efficiently rendering a computerized model to be displayed on a monitor comprising:
an input/output (I/O) interface;
a memory for storing computer readable code for an application module for graphically displaying a computerized model;
at least one processor coupled to the memory, said at least one processor executing the computer readable code in the memory to cause the application module to perform operations of:
receiving a computerized model, said computerized model containing a plurality of elements organized in one or more groups;
determining first and second numbers used for further partitioning of the computerized model with a set of criteria based on available resources of the system, characteristics of the computerized model;
partitioning each group having more than the first number of elements into a plurality of subgroups with each subgroup having less than the second number of elements in accordance with a set of partitioning rules;
dynamically detecting a viewport defined by a user desirous of viewing the computerized model;
designating one or more of the groups and/or the subgroups overlapping the viewport as a set of rendering units; and
rendering said set of rendering units in the system such that portion of the computerized model relevant to the viewport can be efficiently displayed on a monitor operatively adapted thereto.

12. The system of claim 11, wherein said set of partitioning rules comprises dividing said each group in said each group's longest geometric dimension.

13. The system of claim 11, wherein said designating said one or more of the groups and/or the subgroups overlapping the viewport as a set of rendering units further comprises comparing the viewport's geometrical bounds with respective geometric bounds of said each of said one or more of the groups and/or the subgroups.

14. A non-transitory computer readable storage medium containing computer executable instructions for efficiently rendering a computerized model to be displayed on a monitor by a method comprising:
receiving a computerized model in a computer system having a application module for graphically displaying the computerized model installed thereon, said computerized model containing a plurality of elements organized in one or more groups;
determining first and second numbers used for further partitioning of the computerized model with a set of criteria based on available resources of the computer system, characteristics of the computerized model;
partitioning each group having more than the first number of elements into a plurality of subgroups with each subgroup having less than the second number of elements in accordance with a set of partitioning rules;
dynamically detecting a viewport defined by a user desirous of viewing the computerized model;
designating one or more of the groups and/or the subgroups overlapping the viewport as a set of rendering units; and
rendering said set of rendering units in the computer system such that portion relevant to the viewport can be efficiently displayed on a monitor operatively adapted thereto.

15. The non-transitory computer readable storage medium of claim 14, wherein said set of partitioning rules comprises dividing said each group in said each group's longest geometric dimension.

16. The non-transitory computer readable storage medium of claim 14, wherein said designating said one or more of the groups and/or the subgroups overlapping the viewport as a set of rendering units further comprises comparing the viewport's geometrical bounds with respective geometric bounds of said each of said one or more of the groups and/or the subgroups.
